(19) United States
(12) Patent Application Publication
(10) Pub. No.: US 2007/0186101 A1
(43) Pub. Date: Aug. 9, 2007

(54) Trust concept for the SIP reason header

(75) Inventors: Zsolt Rajko, Lovasbereny (HU); Jozsef Varga, Nagydobsza (HU)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/593,077

(22) Filed: Nov. 6, 2006

Related U.S. Application Data
(60) Provisional application No. 60/765,219, filed on Feb. 6, 2006.

(51) Int. Cl. H04L 9/00

(52) U.S. Cl. 713/161

(57) ABSTRACT

A network element for handling a trusted relationship in an IP multimedia subsystem, the network element includes a receiving unit for receiving a message from another entity, wherein the message includes a header. The network element also includes a determining for determining that an entity from which the message is received is a predefined trusted entity. The header of the message includes information for identifying whether or not the entity from which the message is received is a predefined trusted entity. The network element also includes a processing unit for using contents of the header, from the entity that is determined to be a predefined trusted entity, for applications implemented by the network element.

### BACKGROUND OF THE INVENTION

1. Field of the Invention

The present invention relates to a Session Initiation Protocol network, and in particular, to handling trusted relationships in an IP Multimedia subsystem.

2. Description of the Related Art

In a Session Initiation Protocol (SIP) network, for example an IP multimedia subsystem, there are sceneries when a session is prematurely released due to an error that prevented an end-user from fully benefiting from service(s) provided by the IP multimedia subsystem. For example, when a user equipment crashes, it may not be able to release the current Session Initiation Protocol (SIP) session. However, because on the signalling plane it is not immediately visible that the user equipment has crashed, the session is released later by another terminal or network. For example, the session may be release after a session timer has expired. The user equipment and the network releasing the session provide additional information in a BYE request, which indicates that the expiration of the session timer triggered the session release. This additional information is typically provided in a SIP Reason header. When the information about the premature release is stored in the SIP Reason header, a charging/billing application considers the information included in the SIP Reason header when billing for the session, as it would be unfair to bill the end-user for the entire session.

However, the information currently provided in a SIP message that is sent for releasing the session provides the end-user with an opportunity to avoid proper charges for SIP dialogs. For example, the end-user can send the BYE message to release the session and insert the SIP Reason header, indicating the same cause that is used for session timer expiration, in the SIP message. Based on the contents of the SIP Reason header, the billing application will improperly charge the end-user for the SIP dialog.

### SUMMARY OF THE INVENTION

A network element for handling a trusted relationship in a Session Initiation Protocol network, the network element includes a receiving unit for receiving a message from another entity, wherein the message includes a header and at least one trust token. The network element also includes a determining unit for determining that an entity from which the message is received is a predefined trusted entity. The header of the message includes information for identifying whether or not the entity from which the message is received is a predefined trusted entity. The network element also includes means for processing contents of the header, from the entity that is determined to be a predefined trusted entity, for applications implemented by the network element.

A method for handling a trusted relationship in a Session Initiation Protocol network, the method includes the steps of receiving a message from another entity, wherein the message includes a header and at least one trust token, and determining that an entity from which the message is received is a predefined trusted entity, wherein the header of the message includes information for identifying whether or not the entity from which the message is received is a predefined trusted entity. The method also includes the step of using contents of the header from the entity that is determined to be a predefined trusted entity for applications implemented by the network element.

An apparatus for handling a trusted relationship in a Session Initiation Protocol network, the apparatus includes receiving means for receiving a message from another entity, wherein the message includes a header and at least one trust token. The apparatus also includes determining means for determining that an entity from which the message is received is a predefined trusted entity, wherein the header of the message includes information for identifying whether or not the entity from which the message is received is a predefined trusted entity. The apparatus further includes processing means for using contents of the header, from the entity that is determined to be a predefined trusted entity, for applications implemented by the network element.

An apparatus for sending a message to an entity with a trusted relationship in a Session Initiation Protocol network, the apparatus including a generating unit for generating a request including a message with at least one trust token. The apparatus also includes a transmitting unit for transmitting the request to an entity with a trusted relationship. The entity includes receiving means for receiving the message, wherein the message includes a header and the at least one trust token, determining means for determining that the apparatus from which the message is received is a predefined trusted entity, wherein the header of the message comprises information for identifying whether or not the apparatus from which the message is received is a predefined trusted entity, and processing means for using contents of the header, from the apparatus that is determined to be a predefined trusted entity, for applications implemented by the entity.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an embodiment of an IP Multimedia subsystem in which embodiments of the present invention may be implemented;

FIG. 2 illustrates an embodiment of the IP Multimedia subsystem;

FIG. 3 illustrates another embodiment of the IP Multimedia subsystem;

FIG. 4 illustrates method steps implemented in a first embodiment of the present invention;

FIG. 5 illustrates method steps implemented in a second embodiment of the present invention; and

FIG. 6 illustrates method steps implemented in a third embodiment of the present invention.

### DETAILED DESCRIPTION OF PREFERRED EMBODIMENTS

Reference will now be made to the preferred embodiments of the present invention, examples of which are illustrated in the accompanying drawings.

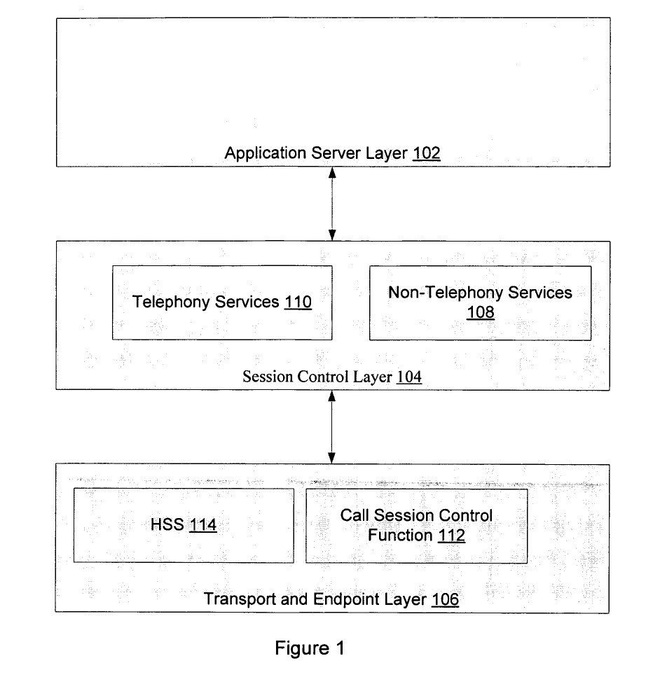

FIG. 1 illustrates an embodiment of an IP Multimedia subsystem 100 in which embodiments of the present invention may be implemented. Subsystem 100 includes an application server layer 102, a session control layer 104 and a transport and endpoint layer 106. Subsystem 100 is a unified architecture that supports a wide range of services enabled by the flexibility of a Session Initiation Protocol (SIP). As shown in FIG. 1, the subsystem 100 can support multiple application servers providing traditional telephony services 108 and non-telephony services 110, such as instant messaging, push-to-talk, and video streaming. Transport and endpoint layer 106 initiates and terminates SIP signalling to set up sessions and provide bearer services such as, conversion of voice from analog or digital formats to Internet Protocol (IP) packets using Realtime Transport Protocol (RTP). Session control layer 104 includes a Call Session Control Function (CSCF) 112, which provides the registration of endpoints and routing of SIP signalling messages to an appropriate application server. The CSCF 112 interworks with transport and endpoint layer 106 to guarantee Quality of Service across all services. Session control layer 104 also includes a Home Subscriber Server (HSS) database 114 that maintains the unique service profile for each end user. The end user's service profile stores all of the user service information and preferences in a central location. This includes an end user's current registration information, roaming information, telephony services, such as call forwarding information, instant messaging service information, such as buddies list, and voice mail box options. Application server layer 102 includes the application servers, which provide the end-user service logic.

In subsystem 100 implementing an SIP message, a header field, for example a Reason header field, which is part of the SIP message, may appear in any request within a dialog. A trust concept is developed for information carried in the SIP Reason header. The trust concept defines when applications can rely on the content of the SIP Reasons header and when they should simply ignore the SIP Reason header. For example, the trust concept defines that the contents of the SIP Reason header should be ignored when it cannot be guaranteed that the contents of the SIP Reason header reflect a real situation. A basic assumption of the present invention is that previously defined trust relationship exists between networks. It should be noted that while embodiments of the present invention describe a Reason header, other SIP headers may be used in embodiments of the present invention to obtain the benefits of the invention.

In a first embodiment of the present invention, the trust concepts for the SIP Reason header are defined based sorely on predefine trust relationships. In this embodiment, when a network element receives a SIP request from another SIP entity, which is considered trusted, then the content of the SIP Reason header is considered to be trustworthy. If the network element receives the SIP request from a non-trusted SIP entity, then the network element does not rely on the contents of the SIP Reason header. In accordance with an embodiment of the present invention, the network element then removes the SIP Reason header from the SIP message because if the network element keeps the non-trusted SIP Reason header in the SIP message and forwards the SIP message to another trusted network element, then the other network element may consider the content of the SIP Reason header to be trusted.

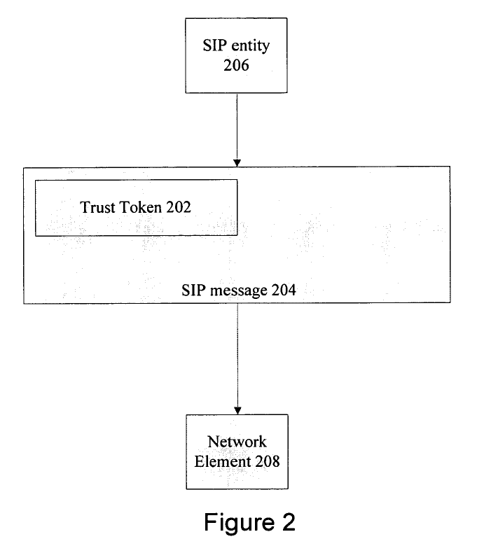

A second embodiment of the present invention, as illustrated in FIG. 2, provides a trust concept for the SIP Reason header based on predefined trust relationship and an additional new trust token 202, which is inserted into the SIP message 204. The trust token may be a parameter of the SIP Reason header or a separate header. The trust token includes one field that includes an identifier of the SIP entity, for example the address of SIP proxy. The SIP entity 206 generating the SIP request puts trust token 202 including its own identifier into the message. In this embodiment, when network element 208 receives an SIP message from trusted SIP entity 206, network element 208 checks whether or not trust token 202 exists in message 204. If trust token 202 exists in message 204 and if trust token 202 includes the identifier of SIP entity 206 from which the message has been received, then network element 208 can rely on the content of the SIP Reason header. Network element 208 then overwrites the identifier in token 202 with its own identifier. If trust token 202 is missing or if trust token 202 includes a different identifier from the identifier of SIP entity 206 from which the message has been received, then network element 208 does rely on the content of the SIP Reason header and removes any present token from SIP message 204. In this embodiment, when network element 208 receives SIP message 204 from a non-trusted SIP entity, network element 208 does not rely on the content of the SIP Reason header and network element 208 removes any present token from the SIP message, without removing the SIP Reason header from the message.

It should be noted that a network element not supporting the additional trust token will not touch the trust token. Thereafter, any further network element receiving the message will determine that the identifier in the token is different from the identifier from the entity from which the message is sent and therefore will not trust the content of the SIP Reason header.

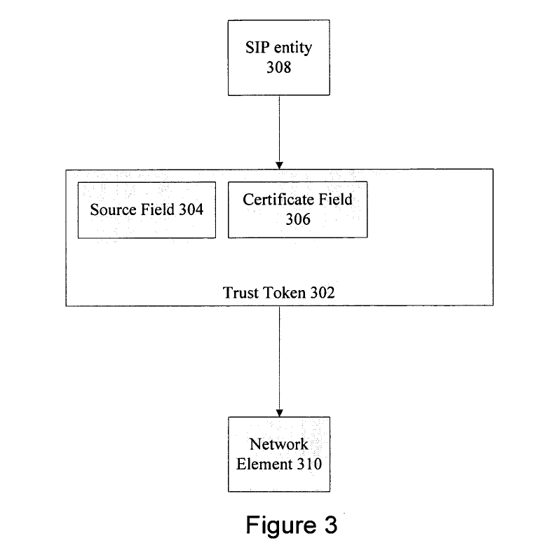

A third embodiment of the present invention, illustrated in FIG. 3, provides a trust concept for the SIP Reason header based on predefined trust relationship and an additional new trust token 302 which includes a source field 304 and a certificate field 306. Source field 304 identifies SIP entity 308 that inserted the SIP Reason header into the SIP message. Certificate field 306 identifies that the last SIP entity to certify that the SIP Reason header was really the entity identified by source field 304 and that the SIP Reason header was not changed by another non-trusted entity. In this embodiment, SIP entity 308 that generates the SIP request inserts a trust token into the SIP message and inserts its own identifier in both the source and certificate fields. Trust token 302 in this embodiment means that network element 310 can be sure that the SIP Reason header was actually inserted into the SIP message by the entity whose address is present in the SIP Reason header. When network element 310 receives the SIP message from a trusted SIP entity 308, network element 310 determines if trust token 302 exists in the message and if certificate field 306 includes the identifier of SIP entity 308 from which the message has been received. If network element 310 determines that trust token 302 exists and that certificate field 306 includes the identifier of the SIP entity from which the message has been received, network element 310 can then be sure that source field 304 of trust token 302 is valid. If network element 310 has a trust relationship with the entity identified in source field 304 of trust token 302, then network element 310 can rely on the content of the SIP Reason header, otherwise network element 310 ignores the content of the SIP Reason Header. Regardless of whether network element 310 relies on or ignores the content of the SIP Reason header, network element 310 writes its own identifier to certificate field 306 of trust token 302.

If network element 310 determines that trust token 302 exists and that certificate field 306 includes the identifier of a different SIP entity and not an identifier of the SIP entity from which the message has been received, network element 310 can not be sure that source field 304 of trust token 302 is valid. Network element 310, in this case, removes trust token 302 from the SIP message and does not rely on the content of the SIP Reason header. If trust token 302 is missing from the message or if network element 310 receives a SIP message from a non-trusted SIP entity, then network element 310 does not rely on the content of the SIP Reason header.

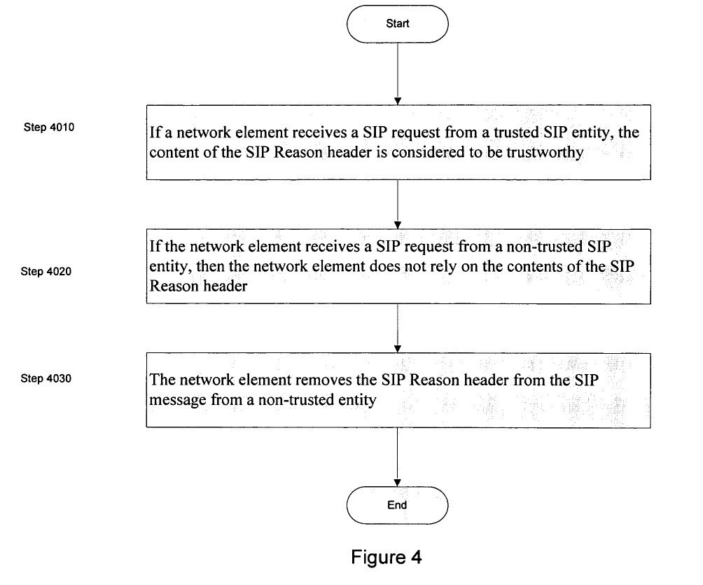

FIG. 4 illustrates the steps implemented in the first embodiment of the present invention. In Step 4010, if a network element receives a SIP request from a trusted SIP entity, the content of the SIP Reason header is considered to be trustworthy. In Step 4020, if the network element receives a SIP request from a non-trusted SIP entity, then the network element does not rely on the contents of the SIP Reason header. In Step 4030, the network element removes the SIP Reason header from the SIP message from a non-trusted entity.

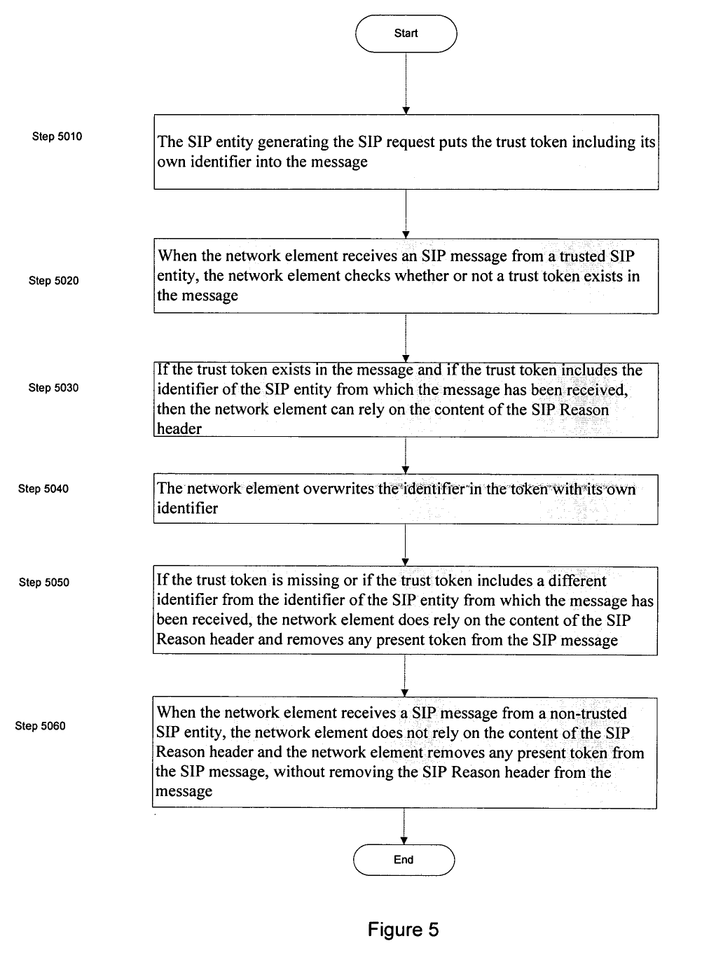

FIG. 5 illustrates the steps implemented in the second embodiment of the present invention. In Step 5010, the SIP entity generating the SIP request puts the trust token including its own identifier into the message. In Step 5020, when the network element receives an SIP message from a trusted SIP entity, the network element checks whether or not the trust token exists in the message. In Step 5030, if the trust token exists in the message and if the trust token includes the identifier of the SIP entity from which the message has been received, then the network element can rely on the content of the SIP Reason header. In Step 5040, the network element overwrites the identifier in the token with its own identifier. In Step 5050, if the trust token is missing or if the trust token includes a different identifier from the identifier of the SIP entity from which the message has been received, the network element does rely on the content of the SIP Reason header and removes any present token from the SIP message In Step 5060, when the network element receives a SIP message from a non-trusted SIP entity, the network element does not rely on the content of the SIP Reason header and the network element removes any present token from the SIP message, without removing the SIP Reason header from the message.

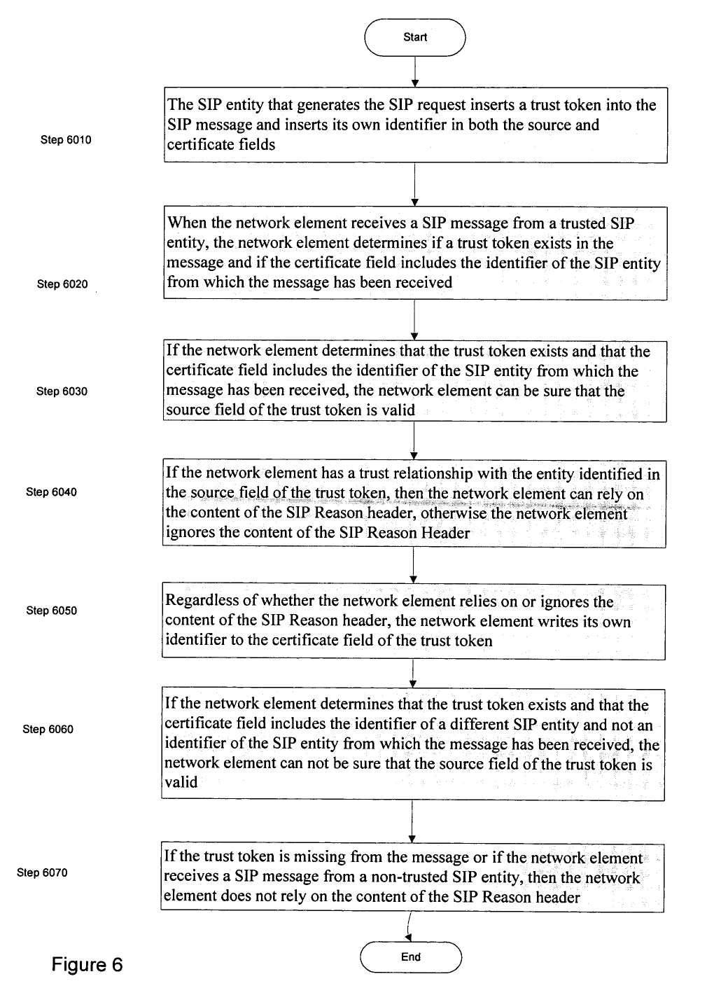

FIG. 6 illustrates the steps implemented in a third embodiment of the present invention. In Step 6010, the SIP entity that generates the SIP request inserts a trust token into the SIP message and inserts its own identifier in both the source and certificate fields. In Step 6020, when the network element receives a SIP message from a trusted SIP entity, the network element determines if the trust token exists in the message and if the certificate field includes the identifier of the SIP entity from which the message has been received. In Step 6030, if the network element determines that the trust token exists and that the certificate field includes the identifier of the SIP entity from which the message has been received, the network element can be sure that the source field of the trust token is valid. In Step 6040, if the network element has a trust relationship with the entity identified in the source field of the trust token, then the network element can rely on the content of the SIP Reason header, otherwise, the network element ignores the content of the SIP Reason Header. In Step 6050, regardless of whether the network element relies on or ignores the content of the SIP Reason header, the network element writes its own identifier to the certificate field of the trust token.

In Step 6060, if the network element determines that the trust token exists and that the certificate field includes the identifier of a different SIP entity and not an identifier of the SIP entity from which the message has been received, the network element can not be sure that the source field of the trust token is valid. The network element, in this case, removes the trust token from the SIP message and does not rely on the content of the SIP Reason header. In Step 6070, if the trust token is missing from the message or if the network element receives a SIP message from a non-trusted SIP entity, then the network element does not rely on the content of the SIP Reason header.

The present invention, therefore, provides more reliable data for charging an end-user. In the first embodiment, once the content of the SIP Reason header is determined to be un-trustworthy, the SIP Reason header is removed from the SIP messages. Thus, the SIP Reason header cannot be used even for such purposes where the reliability of the data is not important. For example, content of the SIP Reason header will not be rendered to an end-user's terminal. The third embodiment of the present invention provides a solution for a case where there are three network elements, whereby there is a trust relationship between network element A and network element C, and a trust relationship between network element B and network element C. In the third embodiment, if network element A generates a SIP request message, which is sent to network element B to be forwarded to network element C, since network element B does not have a trust relationship with network element A, network element B will ignore the content of the SIP Reason header and write its own identifier to the certificate field before forwarding the message to network element C. When network element C receives the message, network element C will see that the message is sent from network element B which should have verified that the certificate field included the identifier network element A, from which the message was received. Since network element C has a trusted relationship with network element A, network element C may then rely on the content of the SIP Reason header.

It should be appreciated by one skilled in art, that the present invention may be utilized in any device that implements the SIP message described above. The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

What is claimed:

1. A network element for handling a trusted relationship in a Session Initiation Protocol network, the network element comprising:
a receiving unit for receiving a message from another entity, wherein the message includes a header and at least one trust token;
a determining unit for determining that an entity from which the message is received is a predefined trusted entity, wherein the header of the message comprises information for identifying whether or not the entity from which the message is received is a predefined trusted entity; and
a processing unit for using contents of the header, from the entity that is determined to be a predefined trusted entity, for applications implemented by the network element.

2. The network element of claim 1, wherein the network element is configured to accept the trust token as a parameter of a SIP Header or a separate header, wherein an entity generating the message inserts the trust token including an identifier of the generating entity in the message.

3. The network element of claim 1, wherein the network element is configured, based on the determining unit, to determine that the entity from which the message is received is a predefined trusted entity and that the contents of the header in the received message is to be trusted.

4. The network element of claim 1, wherein the network element is configured, based on the determining unit, to determine that the entity from which the message is received is not a predefined trusted entity and the network element is configured to remove the header from the message.

5. The network element of claim 1, wherein the network element is configured to determine whether or not the trust token is associated with the header and if the associated trust token includes an identifier of the entity from which the message is received,
wherein if the associated trust token includes an identifier of the entity from which the message is received, the network element is configured to rely on the contents of the header and to overwrite an identifier in the trust token with an identifier associated with the network element.

6. The network element of claim 1, wherein the network element is configured to determine whether or not the trust token is associated with the header and if the associated trust token includes an identifier of the entity from which the message is received,
wherein if the network element determines that there is no trust token in the header or that the trust token includes an identifier of an entity which did not send the message, the network element is configured to remove the trust token from the message and ignore the content of the header.

7. The network element of claim 1, wherein the network element is configured to determine whether or not the trust token is associated with the header and if the associated trust token includes a certificate field for identifying a previous entity that certified a SIP Header in the message,
wherein if the associated token includes the certificate field of the previous entity that certified the SIP Header in the message and from which the message is received, the network element is configured to assume that a source field in the token is valid and if the network element has a trust relationship with the entity identified in the source field, the network element is configured to rely on the contents of the header, and wherein the network element if further configured to overwrite an identifier in the certificate field with an identifier associated with the network element.

8. The network element of claim 1, wherein the network element is configured to determine whether or not the trust token is associated with the header and if the associated trust token includes a certificate field for identifying a previous entity that certified a SIP Header in the message,
wherein if the certificate field includes an identifier of the entity that did not previously certify the SIP Reason Header in the message and sent the message, the network element is configured to assume that a source field in the token is invalid and the network element removes the token from the message and does not rely on the content of the header.

9. A method for handling a trusted relationship in a Session Initiation Protocol network, the method comprises the steps of:
receiving a message from another entity, wherein the message includes a header and at least one trust token;
determining that an entity from which the message is received is a predefined trusted entity, wherein the header of the message comprises information for identifying whether or not the entity from which the message is received is a predefined trusted entity; and
using contents of the header, from the entity that is determined to be a predefined trusted entity, for applications implemented by the network element.

10. The method of claim 9, further comprising accepting the trust token as a parameter of a SIP Header or a separate header, wherein an entity generating the message inserts the trust token including an identifier of the generating entity in the message.

11. The method of claim 9, further comprising determining that the entity from which the message is received is a predefined trusted entity and that the contents of the header in the received message is to be trusted.

12. The method of claim 9, further comprising determining that the entity from which the message is received is not a predefined trusted entity and the network element is configured to remove the header from the message.

13. The method of claim 9, further comprising determining whether or not the trust token is associated with the header and if the associated trust token includes an identifier of the entity from which the message is received,
wherein if the associated trust token includes an identifier of the entity from which the message is received, the network element is configured to rely on the contents of the header and to overwrite an identifier in the trust token with an identifier associated with the network element.

14. The method of claim 9, further comprising determining whether or not the trust token is associated with the header and if the associated trust token includes an identifier of the entity from which the message is received,
wherein if the network element determines that there is no trust token in the header or that the trust token includes an identifier of an entity which did not send the message, the network element is configured to remove the trust token from the message and ignore the content of the header.

15. The method of claim 9, further comprising determining whether or not the trust token is associated with the header and if the associated trust token includes a certificate field for identifying a previous entity that certified a SIP Header in the message,
wherein if the associated the token includes the certificate field of the previous entity that certified the SIP Header in the message and from which the message is received, the network element is configured to assume that a source field in the token is valid and if the network element has a trust relationship with the entity identified in the source field, the network element is configured to rely on the contents of the header, and wherein the network element if further configured to overwrite an identifier in the certificate field with an identifier associated with the network element.

16. The method of claim 9, further comprising determining whether or not the trust token is associated with the header and if the associated trust token includes a certificate field for identifying a previous entity that certified a SIP Header in the message,
wherein if the certificate field includes an identifier of the entity that did not previously certify the SIP Header in the message and sent the message, the network element is configured to assume that a source field in the token is invalid and the network element removes the token from the message and does not rely on the content of the header.

17. An apparatus for handling a trusted relationship in an Session Initiation Protocol network, the apparatus comprising:
receiving means for receiving a message from another entity, wherein the message includes a header and at least one trust token;
determining means for determining that an entity from which the message is received is a predefined trusted entity, wherein the header of the message comprises information for identifying whether or not the entity from which the message is received is a predefined trusted entity; and
processing means for using contents of the header, from the entity that is determined to be a predefined trusted entity, for applications implemented by the network element.

18. An apparatus for sending a message to an entity with a trusted relationship in a Session Initiation Protocol network, the apparatus comprising:
a generating unit for generating a request including a message with at least one trust token; and
a transmitting unit for transmitting the request to an entity with a trusted relationship, wherein the entity comprises receiving means for receiving the message, wherein the message includes a header and the at least one trust token, determining means for determining that the apparatus from which the message is received is a predefined trusted entity, wherein the header of the message comprises information for identifying whether or not the apparatus from which the message is received is a predefined trusted entity, and processing means for using contents of the header, from the apparatus that is determined to be a predefined trusted entity, for applications implemented by the entity.

19. The apparatus of claim 18, wherein the apparatus is configured to generate an SIP request message with the trust token including an identifier associated with the apparatus.

20. The apparatus of claim 18, wherein the apparatus is configured to generate an SIP request message with the trust token including an identifier associated with the apparatus in both a source field and a certificate field.
